(19) United States
(12) Patent Application Publication
(10) Pub. No.: US 2005/0278927 A1
(43) Pub. Date: Dec. 22, 2005

(54) Fan mount

(76) Inventor: John W. Campbell, Monument, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/874,936

(22) Filed: Jun. 22, 2004

(51) Int. Cl. B23P 11/02

(52) U.S. Cl. 29/453; 29/446

(57) ABSTRACT

In one embodiment, a fan mount has a unitary elastomeric structure. The unitary elastomeric structure has a number of fan assembly retainers molded therein, and a number of mounting feet molded therein. In another embodiment, a fan mount has an elastomeric band, shaped to follow a perimeter of a fan assembly, with a number of elastomeric mounting feet extending therefrom. A related method includes 1) deforming an elastomeric fan mount to capture a fan assembly therein, and 2) engaging a number of mounting feet, which extend from the elastomeric fan mount, with installation capture slots on an installation surface.

### BACKGROUND OF THE INVENTION

The class of fans known as “tube-axial” fans are commonly used for ventilation purposes. Typically, fans of this type are mounted using screws, press-in plastic grommet fasteners, spring clips with screws, one-piece spring clips, or 'bend-up' locking tabs formed in a sheet metal mounting surface. These mounting means can be complex, and time consuming to assemble. Many of them also require the awkward handling and application of screws and/or other special installation hardware, sometimes requiring the use of special tools. This leads to increased assembly costs. Furthermore, metallic screws, spring clips, and hard-plastic installation hardware contribute to increased fan noise and vibrations. This, in turn, leads to poor customer satisfaction.

### SUMMARY OF THE INVENTION

One aspect of the invention is embodied in a fan mount comprising a unitary elastomeric structure having a number of fan assembly retainers and mounting feet molded therein.

Another aspect of the invention is embodied in a fan mount comprising 1) an elastomeric band, shaped to follow a perimeter of a fan assembly, and 2) a number of elastomeric mounting feet extending from the band.

Yet another aspect of the invention is embodied in a method for mounting a fan. The method comprises 1) deforming an elastomeric fan mount to capture a fan assembly therein, and 2) engaging a number of mounting feet, extending from the elastomeric fan mount, with installation slots on an installation surface.

Other embodiments of the invention are also disclosed.

### BRIEF DESCRIPTION OF THE DRAWINGS

Illustrative and presently preferred embodiments of the invention are illustrated in the drawings, in which:

FIG. 1 provides a perspective view of a first exemplary embodiment of a fan mount;

FIG. 2 provides a second perspective view of the FIG. 1 fan mount;

FIG. 3 illustrates the installation of a fan assembly in the FIG. 1 fan mount;

FIG. 4 illustrates the installation of the FIG. 1 fan mount on an installation surface; and

FIG. 5 illustrates an alternate embodiment of a mounting foot for the FIG. 1 fan mount.

### DESCRIPTION OF THE PREFERRED EMBODIMENT

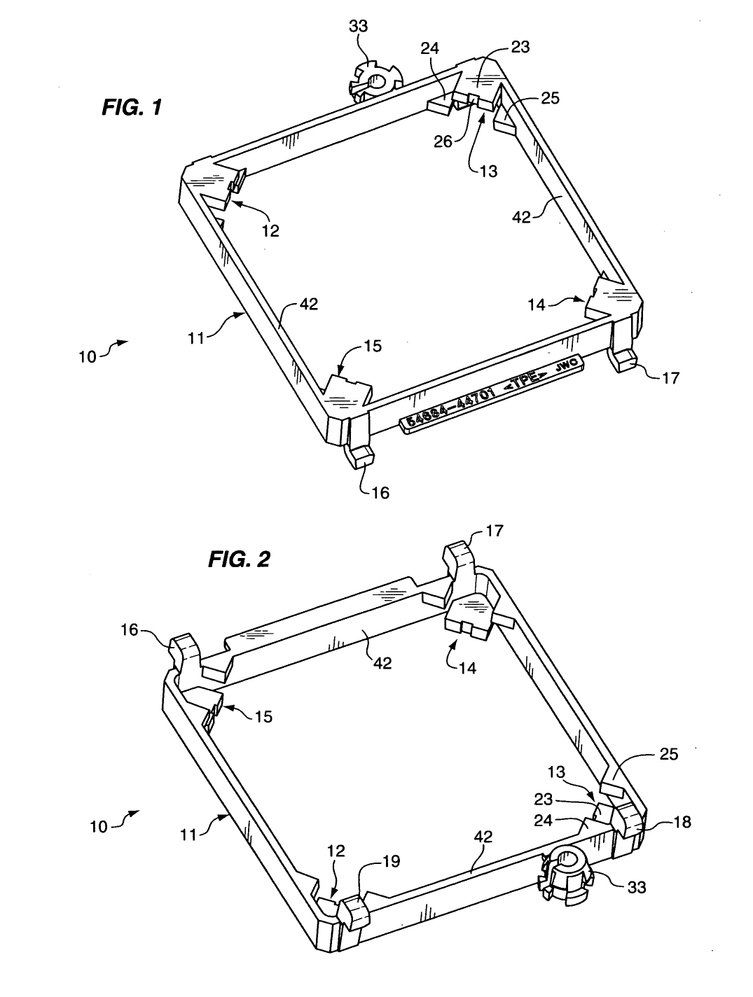

As shown in FIGS. 1 & 2, one aspect of the invention is embodied in a fan mount 10. The fan mount 10 comprises a unitary elastomeric structure 11. The unitary elastomeric structure 11 has a number of fan assembly retainers 12-15 and mounting feet 16-19 molded therein.

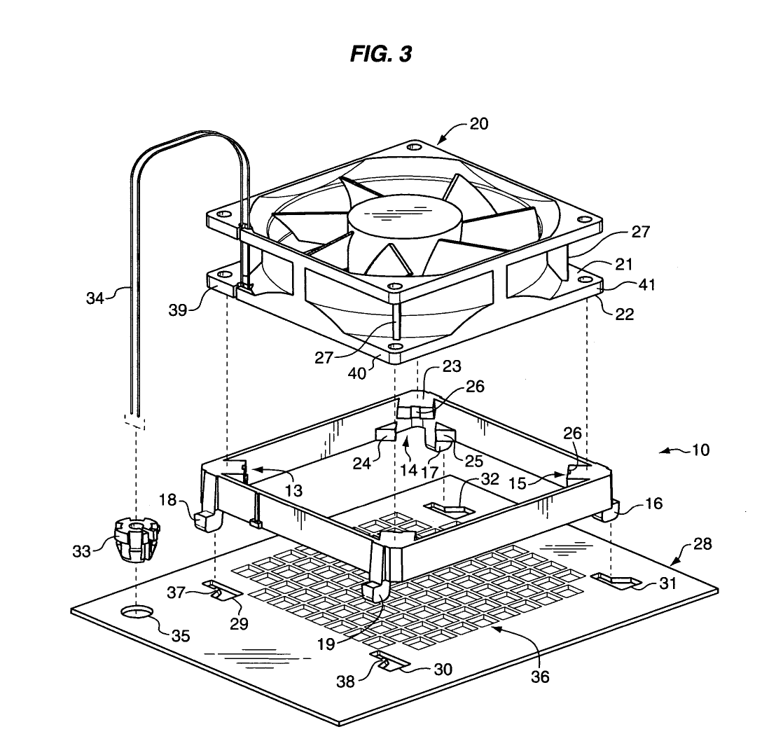

The unitary elastomeric structure 11 of the fan mount 10 may be shaped to follow the perimeter of a fan assembly 20 and, in one embodiment, the structure 11 may generally follow the contours of flanges 39, 40, 41 of the fan assembly 20 (see FIGS. 3 & 4). As used herein, a fan flange 39 is intended to include any stationary fan part that may be grasped for purposes of mounting a fan assembly 20.

The unitary elastomeric structure 11 of the fan mount 10 shown in FIG. 3 is approximately square. However, some fan assemblies are round or roundish, and the fan mount 10 could alternately be configured for these and other shapes and/or sizes of fan assemblies.

The unitary elastomeric structure 11 may be an injection molded part, made from any suitable thermoplastic elastomer. By way of example, the thermoplastic elastomeric material may be Santoprene® with shore 64A hardness. However, any suitable elastomeric material may be used to manufacture the unitary elastomeric structure 11. Also, injection molding is only one of various molding methods which may be used to manufacture the unitary elastomeric structure 11. Additionally, the hardness of the elastomeric material may be varied depending on the shape, size, speed and weight of the fan to be mounted, as well as the size of the fan mount 10.

As shown in FIG. 1, the fan assembly retainers 12-15 may extend inward from the unitary elastomeric structure 11, thereby grasping flanges 39-41 of the fan assembly 10. At least one of the fan assembly retainers 12-15 may have portions 23, 24, 25 to respectively grasp upper and lower portions 21, 22 of the fan assembly 20.

As shown in FIGS. 1 & 2, the fan assembly retainers 12-15 may comprise generally rectangular 23 and triangular 24-25 extensions that project inward from the unitary elastomeric structure 11. However, the fan assembly retainers 12-15 could also take other forms, and can alternately extend from, or recess into, the unitary elastomeric structure 11. In yet another embodiment of the invention, one or more of the fan assembly retainers 12-15 may be provided with a slot 26 or ridge for receiving or engaging a rib 27 or detent of the fan assembly 20.

Note that the triangular extensions 24-25 project inward and provide an elastomeric base upon which the lower portion 22 of the fan assembly 20 may rest. The triangular extensions 24-25 therefore ensure that the fan assembly 20 remains separated from an installation surface 28, thereby reducing the propagation of noise and vibrations during fan operation.

In one embodiment, the fan assembly retainers 12-15 are located at each of the four corners of the fan mount 10, as shown in FIGS. 1 & 2. Alternately, the fan assembly retainers 12-15 may be located at locations other than the corners of the fan assembly 20. For example, the fan assembly retainers 12-15 could be located at fewer than all of the corners, or they could be located at all of the corners plus additional non-corner locations. In yet another embodiment, a round or partially round fan assembly may be retained at several spaced-apart locations around the fan assembly. Alternately, a larger or heavier fan may require a greater number of fan assembly retainers 12-15 to secure the fan assembly 20. The number of fan assembly retainers 12-15 may therefore depend on the shape or size of a fan that is to be mounted.

As shown in FIGS. 3 & 4, the mounting feet 16-19 extend from the unitary elastomeric structure 11 to mechanically couple the fan mount 10 to an installation surface 28. As shown in FIGS. 1 & 2, the mounting feet 16-19 may extend substantially perpendicularly from the unitary elastomeric structure 11, near each of its four corners. As previously recited above in reference to the fan assembly retainers 12-15, the mounting feet 16-19 could alternately be molded into the unitary elastomeric structure 11 at locations other than at the corners of the fan assembly 20. Further, the mounting feet 16-19 could alternately extend from the unitary elastomeric structure 11 in a non-perpendicular manner, and could extend from various surfaces of the unitary elastomeric structure 11. Also, the number of mounting feet 16-19 extending from the unitary elastomeric structure 11 may be different from the number of fan assembly retainers 12-15.

The mounting feet 16-19 may assume a variety of shapes and sizes. As shown in FIGS. 1 & 2, the mounting feet 16-19 may be approximately hook-shaped (e.g., J-shaped) feet. As will be described later in this description, the hooked ends of the mounting feet 16-19 can be used to maintain a mechanical connection between the fan mount 10 and an installation surface 28. In an alternate embodiment, the mounting feet 43 (FIG. 5) may be bullet-shaped, and may optionally comprise pull tabs 45 to aid in pulling the feet through installation slots 44 on an installation surface. The bullet shape of the feet 43 may be a substantially round one, an elliptical one, or any other bullet-type shape. Alternately, the mounting feet 16-19 could have a square cross-section.

Pull tabs may extend from the mounting feet 16-19 to assist in guiding (i.e. pulling) them through openings on an installation surface.

In another embodiment, the fan mount 10 may comprise a grommet 33 that is detachably molded with the unitary elastomeric structure 11. The grommet 33 may be detached during assembly of the fan mount 10 with a fan assembly 20. After the grommet 33 is detached from the fan mount 10, wires 34 may be inserted into the grommet 33, and the grommet 33 may be press fit into an opening 35 in an installation surface 28. The grommet 33 may be used to protect wires 34 as they pass through an opening 35 in an installation surface 28.

The unitary elastomeric structure 11 of the fan mount 10 provides simplified and efficient fan mount 10 installation, which decreases production costs and increases efficiency in manufacture. Further, the unitary elastomeric structure 11 of the fan mount 10 allows for simplified assembly and parts handling (e.g. a reduced part count). Additionally, no special tools or fasteners (e.g., screws or clips) are required for assembly. The fan mount 10 efficiently and securely mounts a fan assembly 20 on an installation surface 28 while reducing manufacturing costs.

The unitary elastomeric structure 11 of the fan mount 10 may also serve to dampen acoustical noise and vibrations during fan operation, thereby increasing overall customer satisfaction.

In an alternate embodiment of the fan mount 10, the fan mount 10 might not be a unitary elastomeric structure 11. That is, another aspect of the invention is embodied in a fan mount 10 comprising an elastomeric band 42 that is shaped to follow a perimeter of a fan assembly 20. In this embodiment, a number of elastomeric mounting feet 16-19 extend from the band 42, but they may not be part of a “unitary” structure with the band 42. For example, they might be bonded or fit to the band 42.

In one embodiment, the band 42 is not provided with fan assembly retainers, and instead “hugs” the fan assembly 20 tight enough to retain it.

The fan mount 10 may further comprise a number of fan assembly retainers 12-15 that extend from the band 42. Possible forms of fan assembly retainers 12-15 have already been described above.

Another aspect of the invention is embodied in a method for mounting a fan. The method comprises deforming an elastomeric fan mount 10 (e.g., twisting or stretching it) to capture a fan assembly 20 within it. A number of mounting feet 16-19 that extend from the fan mount 10 are then engaged with installation capture slots 29-32 provided on an installation surface.

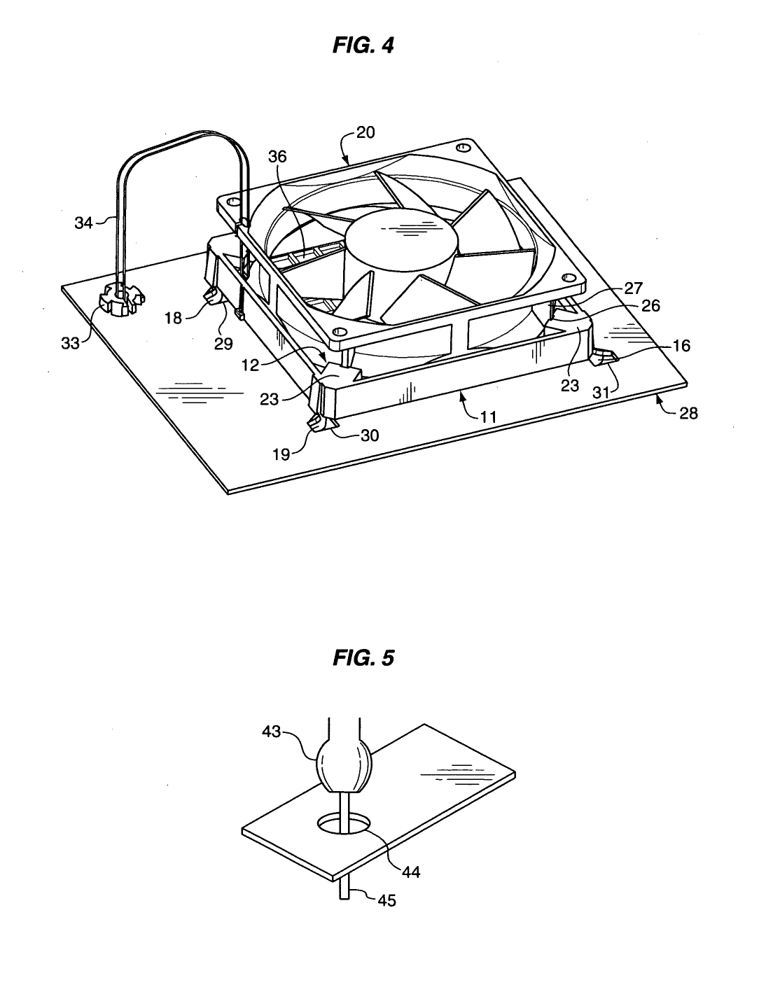

The above method may be applied to the fan mount 10 by inserting a first pair of the fan mount's flanges 40, 39 into a pair of fan assembly retainers 12, 13. By deforming the fan mount 10, the remaining flanges of the fan assembly 20 may then be worked into the remainder of the fan assembly retainers 14, 15. Once the fan assembly 20 is securely captured within the elastomeric fan mount 10 (FIG. 3), the fan mount 10 can be mechanically coupled to an installation surface 28 (FIG. 4).

As shown in FIGS. 3 & 4, the fan mount 10 may be mechanically coupled to an installation surface 28 by engaging its mounting feet 16-19 with installation capture slots 29-32 on an installation surface 28. As shown, the installation surface 28 may be located over a ventilation grate 36, cage, hole, or fan shroud of a device requiring ventilation.

In FIGS. 3 & 4, the fan mount 10 is slid or pushed to one side with respect to the installation surface 28. As the fan mount 10 is slid, the mounting feet 16-19 slide past retainer bumps 37-38 near the installation capture slots 29-32. The retainer bumps 37-38 are not required, but help exert a force which keeps the mounting feet 16-19 from working out of the capture slots 29-32 during fan operation. The elastomeric and somewhat high friction nature of the mounting feet 16-19 also helps to ensure that the fan remains securely mounted on the installation surface 28.

If the fan mount 10 were to comprise bullet-shaped mounting feet 43 such as the one shown in FIG. 5, the fan mount's mounting feet may be engaged with installation capture slots 44 by press fitting the mounting feet into the slots. To assist in the press fitting, pull tabs 45 extending from the mounting feet may be used to guide the mounting feet through the slots.

If, for example, a fan assembly and corresponding fan mount were round, the fan mount's mounting feet may be engaged with installation capture slots by rotating the fan mount with respect to an installation surface.

Optionally, any of the afore-mentioned methods for mounting a fan may comprise detaching an elastomeric grommet 33 from an elastomeric fan mount 10. As previously described above, the grommet 33 may be a molded part of the elastomeric fan mount 10, that may be detached during assembly. After the grommet 33 is removed from the fan mount 10, wires 34 may then be inserted into the grommet 33, and the grommet 33 may be press fit into an opening 35 in an installation surface 28. Of note, no special tools or screws are required for installation of the grommet 33. Therefore, the grommet 33 is free of additional part costs and part number handling.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A fan mount, comprising:
a unitary elastomeric structure having: i) a number of fan assembly retainers molded therein; and ii) a number of mounting feet molded therein.

2. The fan mount of claim 1, wherein the unitary elastomeric structure is shaped to follow a perimeter of a fan assembly.

3. The fan mount of claim 1, wherein the fan assembly retainers extend inward from the unitary elastomeric structure.

4. The fan mount of claim 1, wherein at least one of the fan assembly retainers has portions to grasp upper and lower portions of the fan assembly.

5. The fan mount of claim 1, further comprising pull tabs, coupled to the mounting feet.

6. The fan mount of claim 1, wherein the mounting feet are hook-shaped.

7. The fan mount of claim 1, wherein the mounting feet are bullet-shaped.

8. The fan mount of claim 1, wherein the unitary elastomeric structure further comprises a grommet, detachably molded with the unitary elastomeric structure.

9. A fan mount, comprising:
an elastomeric band, shaped to follow a perimeter of a fan assembly; and
a number of elastomeric mounting feet extending from the band.

10. The fan mount of claim 9, further comprising a number of elastomeric fan assembly retainers extending from the band.

11. The fan mount of claim 9, wherein the fan mount further comprises a grommet, detachably molded with the band.

12. A method for mounting a fan, comprising:
deforming an elastomeric fan mount to capture a fan assembly therein, and
engaging a number of mounting feet, extending from the elastomeric fan mount, with installation slots on an installation surface.

13. The method of claim 12, wherein deforming the elastomeric fan mount further comprises stretching the elastomeric fan mount to engage a number of fan assembly retainers of the fan mount with flanges on the fan assembly.

14. The method of claim 12, wherein deforming the elastomeric fan mount further comprises twisting the elastomeric fan mount to engage a number of fan assembly retainers of the fan mount with flanges on the fan assembly.

15. The method of claim 12, wherein engaging the mounting feet with the installation capture slots further comprises press fitting the mounting feet into the installation capture slots.

16. The method of claim 12, wherein engaging the mounting feet with the installation capture slots further comprises grasping a pull tab of at least one of the mounting feet to guide the mounting feet through one of the installation capture slots.

17. The method of claim 12, wherein engaging the mounting feet with the installation capture slots further comprises sliding the fan mount with respect to the installation surface.

18. The method of claim 12, wherein engaging the mounting feet with the installation capture slots further comprises rotating the fan mount with respect to the installation surface.

19. The method of claim 12, further comprising:
detaching an elastomeric grommet from the elastomeric fan mount;
press fitting the grommet into a hole on the installation surface; and
guiding wires of the fan assembly through the grommet.
